(19) United States
(12) Patent Application Publication
(10) Pub. No.: US 2011/0227690 A1
(43) Pub. Date: Sep. 22, 2011

(54) SOFT MAGNETIC MATERIAL, COMPACT, DUST CORE, ELECTROMAGNETIC COMPONENT, METHOD OF PRODUCING SOFT MAGNETIC MATERIAL, AND METHOD OF PRODUCING DUST CORE

(75) Inventors: Asako Watanabe, Itami-shi (JP); Toshihiro Sakamoto, Itami-shi (JP)

(73) Assignee: SUMITOMO ELECTRIC INDUSTRIES, LTD., Osaka-shi (JP)

(21) Appl. No.: 13/131,746

(22) PCT Filed: Jun. 29, 2010
(86) PCT No.: PCT/JP2010/061020

§ 371 Date: May 27, 2011

(30) Foreign Application Priority Data
Jun. 30, 2009 (JP) 2009-155169
May 25, 2010 (JP) 2010-119113

(51) Int. Cl. H01F 17/04; H01F 1/12; B29C 71/02

(52) U.S. Cl. 336/221; 252/62.51 R; 264/234

(57) ABSTRACT

A soft magnetic material includes a plurality of magnetic particles, a binder, and a lubricant. The binder binds the plurality of magnetic particles. The lubricant is contained in the aggregate of the bound magnetic particles, and has a melting point less than or equal to 100° C. The method of producing a soft magnetic material includes the steps of forming an additive by mixing a binder and a lubricant including fatty acid monoamide, and binding the plurality of magnetic particles by the additive.

### TECHNICAL FIELD

The present invention relates to a soft magnetic material, a compact, a dust core, an electromagnetic component, a method of producing a soft magnetic material, and a method of producing a dust core.

### BACKGROUND ART

A circuit that converts energy such as a switching power supply and boosting converter conventionally use an electromagnetic component employing a dust core as an inductance. The dust core is formed of a plurality of composite magnetic particles. Each of the plurality of composite magnetic particles includes a metal magnetic particle such as of pure iron, for example, and an insulation coat covering the surface thereof. As an example of an electromagnetic component employing a dust core, there is known a component including a dust core and a coil having a wire wound around the core. The dust core requires the magnetic property of allowing a large flux density to be obtained by application of a small magnetic field, and the magnetic property of reacting quickly to an externally applied magnetic field.

In the case where the dust core is employed in an alternating magnetic field, energy loss, also termed iron loss, occurs. This iron loss is represented by the sum of hysteresis loss and eddy current loss. Hysteresis loss is the energy loss caused by the energy required to change the flux density of the dust core, whereas eddy current loss is the energy loss caused by the eddy current flowing in and between each of the metal magnetic particles mainly constituting the dust core. The hysteresis loss is proportional to the operating frequency. The eddy current loss is proportional to the square of the operating frequency. Therefore, the hysteresis loss is dominant mainly in the low frequency range whereas the eddy current loss is dominant mainly in the high frequency range. In other words, the eddy current loss constitutes a large ratio in the iron loss of the dust core directed to high frequency driving. In order to suppress the eddy current loss, the particle size of the metal magnetic particle must be reduced.

As a material for the dust core reduced in the particle size of metal magnetic particles, Japanese Patent Laying-Open No. 2004-319652 (Patent Document 1), for example, discloses soft magnetic powder including a plurality of composite magnetic particles, formed of a metal magnetic particle having a particle size of 5-70 μm, and iron and silicide as the main component, and an insulation coat formed on the surface of the metal magnetic particle, obtained by external oxidation on the metal magnetic particle. The soft magnetic powder is mixed with a lubricant, subjected to the pressure of 16 ton/cm² to produce a dust core.

### PRIOR ART DOCUMENT

### Patent Document

Patent Document 1: Japanese Patent Laying-Open No. 2004-319652

### SUMMARY OF THE INVENTION

### Problems to be Solved by the Invention

The soft magnetic powder disclosed in the aforementioned Patent Document 1 has poor flowability since the particle size of the metal magnetic particle is small. Poor flowability leads to unsatisfactory filling property when a die is filled with such soft magnetic powder. Thus, there was a problem that the density of the compact formed by the soft material powder subjected to pressure-formation is generally reduced.

Furthermore, since great pressure is applied in molding the dust core, the extraction pressure in extracting the dust core from the die after pressure-formation is generally increased. This will lead to the generation of a streak, crack, fracture, and the like in the dust core, causing the problem that molding defect will readily occur.

An object of the present invention is to provide a soft magnetic material improved in density and moldability, a compact, a dust core, an electromagnetic component, a method of producing a soft magnetic material, and a method of producing a dust core.

### Means for Solving the Problems

A soft magnetic material of the present invention includes a plurality of magnetic particles, a binder, and a lubricant. The binder binds the plurality of magnetic particles. The lubricant is contained in the aggregate of the bound magnetic particles, and has a melting point less than or equal to 100° C.

The soft magnetic material according to the present invention contains a lubricant having a melting point less than or equal to 100° C. By pressure-forming the soft magnetic material in a die, the lubricant in the magnetic particle is liquefied to be extruded along the face of the die. Since a lubricant is present at the interface between the die and a compact obtained by pressure-forming the soft magnetic material in the die, the extraction pressure for detachment of the compact from the die can be reduced. Thus, the moldability can be improved since generation of a molding defect such as a streak, crack, fracture, and the like in the compact can be suppressed.

Inside the aggregate of the bound magnetic particles, a lubricant that is liquefied at the time of pressure-formation is present, in addition to a binder. Therefore, the lubricant in the binder will promote cohesion failure of the binder when the soft magnetic material is subjected to pressure-formation in a die to reduce the binding force. Accordingly, the plurality of bound magnetic particles can be readily broken apart to facilitate realignment of the magnetic particles. Moreover, the liquefied lubricant contributes to improving the density of the compact since it is readily discharged from the interior of the compact onto the face of the mold. Thus, the density of the compact obtained by pressure-forming the soft magnetic material can be improved.

Furthermore, the flowability is improved since the plurality of magnetic particles are bound by a binder. The filling property is high in the case where the die is filled with such soft magnetic material. As such, the density of the compact can be improved.

A method of producing a soft magnetic material of the present invention includes the steps of forming an additive by mixing a binder and a lubricant having a melting point less than or equal to 100° C., and binding a plurality of magnetic particles by the additive.

According to the method of producing a soft magnetic material of the present invention, the plurality of magnetic particles are bound employing a binder and a lubricant having a melting point less than or equal to 100° C. Therefore, the lubricant can be contained in the aggregate of the bound magnetic particles. Thus, there can be produced a soft magnetic material allowing improvement in the density and moldability.

Preferably in the soft magnetic material, the lubricant includes fatty acid monoamide or fatty acid monoester. In the method of producing a soft magnetic material, the step of forming an additive preferably employs a lubricant including fatty acid monoamide or fatty acid monoester.

Since a lubricant including fatty acid monoamide or fatty acid monoester is readily liquefied during molding, the lubricant is readily extruded along the die face. Thus, the moldability can be further improved, and the density of a compact obtained by pressure-forming the soft magnetic material can be further improved.

In the soft magnetic material set forth above, the lubricant preferably includes unsaturated fatty acid monoamide or unsaturated fatty acid monoester. In the method of producing the soft magnetic material set forth above, the step of forming an additive preferably employs a lubricant including unsaturated fatty acid monoamide or unsaturated fatty acid monoester.

Since a lubricant including unsaturated fatty acid monoamide or unsaturated fatty acid monoester is liquefied during molding more readily than a lubricant including saturated fatty acid monoamide or saturated fatty acid monoester, the lubricant can be readily extruded along the die face. Thus, the moldability can be further improved, and the density of a compact obtained by pressure-forming the soft magnetic material can be further improved.

A compact of the present invention is produced by pressure-forming the soft magnetic material of the present invention.

In accordance with the compact of the present invention, a soft magnetic material allowing improvement in moldability and density is employed. Therefore, by pressure-forming the soft magnetic material, a compact improved in moldability and density can be realized.

A dust core of the present invention is produced by heat-treating the compact of the present invention. A method of producing a dust core of the present invention includes the steps of producing a soft magnetic material by the above-described method of producing a soft magnetic material, applying pressure-formation to the soft magnetic material to form a compact, and heat-treating the compact.

In accordance with the dust core and the method of producing a dust core of the present invention, a soft magnetic material allowing improvement in moldability and density is employed. Therefore, by subjecting the soft magnetic material to pressure-formation and heat treatment, a dust core having favorable moldability and improved in density can be realized.

Preferably, in the step of forming a compact according to the method of producing a dust core, the soft magnetic material is subjected to pressure-formation with the temperature of the soft magnetic material controlled to be greater than or equal to the melting point of the lubricant.

Accordingly, in the step of forming a compact, the lubricant is readily extruded along the die face. Thus, a dust core further improved in moldability and density can be produced.

An electromagnetic component of the present invention includes the dust core set forth above, and a coil wound around the dust core. Namely, the electromagnetic component of the present invention includes the dust core of the present invention, and a coil formed of a wire wound at an outer side of the core.

In accordance with the electromagnetic component of the present invention, a soft magnetic material allowing improvement in moldability and density is employed. Therefore, an electromagnetic component of high density can be realized.

### Effects of the Invention

According to the soft magnetic material, the compact, the dust core, the electromagnetic component, the method of producing a soft magnetic material, and the method of producing a dust core of the present invention, a lubricant having a melting point less than or equal to 100° C. is contained in an aggregate of bound magnetic particles. Therefore, the density and moldability can be improved.

### BRIEF DESCRIPTION OF THE DRAWINGS

FIG. 1 schematically represents a soft magnetic material according to a first embodiment of the present invention.

FIG. 2 schematically represents a soft magnetic material according to a modification of the first embodiment of the present invention.

FIG. 3 is a flowchart of a method of producing a soft magnetic material according to the first embodiment of the present invention.

FIG. 4 schematically represents a soft magnetic material according to a second embodiment of the present invention.

FIG. 5 is a flowchart of a method of producing a soft magnetic material according to the second embodiment of the present invention.

FIG. 6 schematically represents a dust core according to a third embodiment of the present invention.

FIG. 7 is a flowchart of a method of producing a dust core according to the third embodiment of the present invention.

FIG. 8 schematically represents a dust core according to a fourth embodiment of the present invention.

FIG. 9 is a flowchart of a method of producing a dust core according to the fourth embodiment of the present invention.

FIG. 10 schematically represents a soft magnetic material of Comparative Example 1.

FIG. 11 represents the relationship between pressure applied in pressure-formation and the density of a compact according to respective examples.

FIG. 12 represents the relationship between pressure applied in pressure-formation and extraction pressure according to respective examples.

### MODES FOR CARRYING OUT THE INVENTION

Embodiments of the present invention will be described hereinafter with reference to the drawings. In the drawings, the same or corresponding elements have the same reference characters allotted, and description thereof will not be repeated.

### First Embodiment

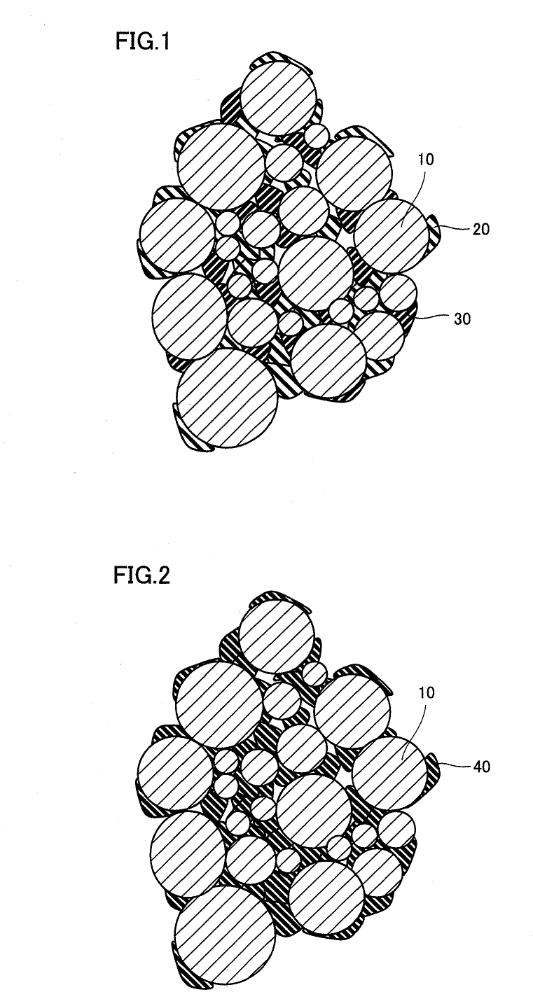

FIG. 1 schematically represents a soft magnetic material according to an embodiment of the present invention. As shown in FIG. 1, the soft magnetic material of the present embodiment includes metal magnetic particles 10 as magnetic particles, a binder 20, and a lubricant 30.

Metal magnetic particles 10 are formed of, for example, iron (Fe), iron (Fe)-aluminium (Al) based alloy, iron (Fe)-silicon (Si) based alloy, iron (Fe)-nitrogen (N) based alloy, iron (Fe)-nickel (Ni) based alloy, iron (Fe)-carbon (C) based alloy, iron (Fe)-boron (B) based alloy, iron (Fe)-cobalt (Co) based alloy, iron (Fe)-phosphorus (P) based alloy, iron (Fe)-nickel (Ni)-cobalt (Co) based alloy, iron (Fe)-aluminium (Al)-silicon (Si) based alloy, iron (Fe)-aluminium (Al)-chromium (Cr) based alloy, iron (Fe)-aluminium (Al)-manganese (Mn) based alloy, iron (Fe)-aluminium (Al)-nickel (Ni) based alloy, iron (Fe)-silicon (Si)-chromium (Cr) based alloy, iron (Fe)-silicon (Si)-manganese (Mn) based alloy, iron (Fe)-silicon (Si)-nickel (Ni) based alloy, iron (Fe) based amorphous alloy, and the like. Metal magnetic particles 10 may be unitary metal or alloy.

The average particle size of a metal magnetic particle 10 is preferably greater than or equal to 1 μm and less than or equal to 70 μm. By setting the average particle size of metal magnetic particle 10 greater than or equal to 1 μm, increase in the coercive force and the hysteresis loss of the dust core produced using the soft magnetic material can be suppressed. Moreover, by setting the average particle size of metal magnetic particle 10 less than or equal to 70 μm, the eddy current loss occurring in the high frequency range greater than or equal to 1 kHz can be reduced effectively.

The average particle size of metal magnetic particle 10 refers to the particle size of a particle when the sum of the mass of particles added in ascending order of particle size in the histogram of particle sizes reaches 50% the total mass, i.e. 50% particle size.

Binder 20 binds the plurality of metal magnetic particles 10. For binder 20, thermoplastic resin, thermosetting resin, and the like can be used. Preferably, binder 20 includes a general purpose solvent compatible with lubricant 30, i.e. capable of melting together with lubricant 30.

Lubricant 30 is contained in the aggregate of bound metal magnetic particles 10. In the soft magnetic material, the additive present inside, not at the outer surface, of the aggregate of bound metal magnetic particles 10, i.e. binder 20 and lubricant 30, is preferably greater than or equal to 50% mass relative to the entire amount of additive.

Lubricant 30 has a melting point less than or equal to 100° C., preferably less than or equal to 75° C. By using a lubricant having such a low melting point, lubricant 30 is liquefied to be readily extruded along the die face during pressure-formation in the die.

Lubricant 30 preferably includes at least one of fatty acid monoamide and fatty acid monoester, more preferably includes fatty acid monoamide or fatty acid monoester. Lubricant 30 is further preferably formed of at least one of fatty acid monoamide and fatty acid monoester, further more preferably formed of fatty acid monoamide or fatty acid monoester. As used herein, fatty acid monoamide is represented by the following chemical formulas 1-3, for example, where R₁, R₂ and R₃ are alkyl groups. Similarly, fatty acid monoester is represented by the following chemical formula 4, for example.

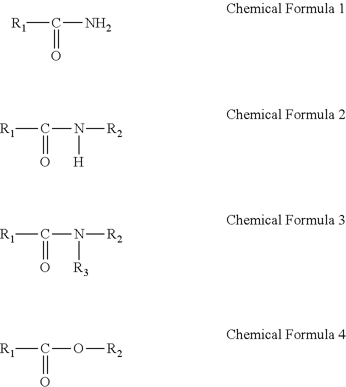

For the fatty acid monoamide, oleic acid amide, erucic acid amide, linolic acid amide, stearin acid amide, caprylic acid amide, lauric acid amide, myristic acid amide, palmitic acid amide, behenic acid amide, for example, and the like, can be enumerated.

Similarly, for fatty acid monoester, oleic acid ester, erucic acid ester, linolic acid ester, stearin acid ester, caprylic acid ester, lauric acid ester, myristic acid ester, palmitic acid ester, behenic acid ester, for example, and the like, can be enumerated.

Furthermore, the fatty acid monoamide and fatty acid monoester are preferably unsaturated. Since unsaturated fatty acid monoamide and unsaturated fatty acid monoester have melting points lower than those of saturated fatty acid monoamide and saturated fatty acid monoester, lubricant 30 is liquefied and readily extruded along the die face in the pressure-forming step with the die. For such an unsaturated fatty acid amide, oleic acid amide, erucic acid amide, linolic acid amide and the like can be used. Similarly, for the unsaturated fatty acid ester, for example, oleic acid ester, erucic acid ester, linolic acid ester and the like can be used.

FIG. 2 schematically represents a soft magnetic material according to a modification of the present embodiment. As shown in FIG. 2, a soft magnetic material includes an additive 40 having binder 20 and lubricant 30 formed integrally. In other words, binder 20 and lubricant 30 may be present individually, as shown in FIG. 1, or in an integrated form, as shown in FIG. 2.

The soft magnetic material of FIG. 1 or 2 may additionally include another additive as long as the property of the soft magnetic material of the present embodiment is not disturbed.

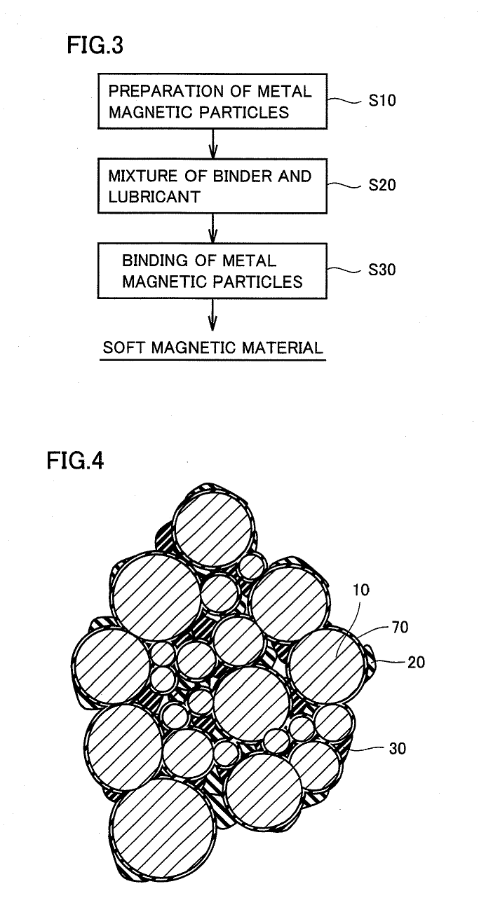

A method of producing a soft magnetic material according to the present embodiment will be described hereinafter with reference to FIGS. 1-3. FIG. 3 is a flowchart of a method of producing a soft magnetic material according to the present embodiment.

As shown in FIG. 3, metal magnetic particles 10 are first prepared (step S10). In this step S10, metal magnetic particles 10 set forth above are prepared. These metal magnetic particles 10 are prepared by subjecting iron containing a predetermined component to gas atomization or water atomization to obtain powder. At step S10, metal magnetic particles 10 having an average particle size greater than or equal to 1 μm and less than or equal to 70 μm is preferable.

Then, metal magnetic particles 10 are heat-treated. The temperature of heat treatment is, for example, higher than or equal to 700° C. and less than 1400° C. The interior of a metal magnetic particle 10 prior to heat treatment may include various defects such as strain and crystal grain boundary due to thermal stress caused during atomization. By applying heat treatment to the metal magnetic particles 10, these defects can be reduced. Optionally, this heat treatment step may be omitted.

Then, binder 20 is mixed with lubricant 30 having a melting point less than or equal to 100° C., preferably less than or equal to 75° C. to form an additive (step S20).

In this step S20, binder 20 and lubricant 30 set forth above are prepared.

Lubricant 30 is dissolved in a solvent of binder 20. The prepared lubricant preferable includes at least one of fatty acid monoamide and fatty acid monoester, more preferably includes fatty acid monoamide or fatty acid monoester. Further preferably, the fatty acid monoamide or fatty acid monoester included in the lubricant is unsaturated.

Then, metal magnetic particles 10 are bound by the additive (step S30). In this step S30, metal magnetic particles 10 are mixed with a solution or fluid dispersion of the additive including binder 20 and lubricant 30, followed by drying away the solvent or fluid dispersion. Resin or another additive may further be added, as necessary. Accordingly, metal magnetic particles 10 are bound by binder 20. A soft magnetic material having lubricant 30 contained in the aggregate of bound metal magnetic particles 10 is obtained.

By performing steps S10-S30 set forth above, the soft magnetic material shown in FIG. 1 or 2 can be produced.

### Second Embodiment

FIG. 4 schematically represents a soft magnetic material according to the present embodiment. As shown in FIG. 4, the soft magnetic material of the present embodiment base has a structure basically similar to that of the soft magnetic material of the first embodiment. The difference lies in that an insulation coat 70 is further provided.

Specifically, the magnetic particles of the present embodiment include a metal magnetic particle 10, and an insulation coat 70 surrounding the periphery of metal magnetic particle 10. Insulation coat 70 functions as an insulating layer between metal magnetic particles 10. By covering metal magnetic particle 10 with insulation coat 70, the electrical resistivity ρ of the dust core obtained by pressure-forming the soft magnetic material can be increased. Accordingly, the flow of eddy current between metal magnetic particles 10 can be suppressed to reduce the eddy current loss of the dust core.

The average film thickness of insulation coat 70 is preferably greater than or equal to 10 nm and less than or equal to 1 μm. By setting the average film thickness of insulation coat 70 greater than or equal to 10 nm, eddy current loss can be suppressed effectively. By setting the average film thickness of insulation coat 70 less than or equal to 1 μm, shear fracture of insulation coat 70 during pressure-formation can be prevented. Moreover, since the ratio of insulation coat 70 constituting the soft magnetic material is not so great, significant reduction in the flux density of the dust core obtained by pressure-forming the soft magnetic material can be prevented.

The average film thickness is determined by deriving the equivalent thickness in view of the film composition obtained by composition analysis (TEM-EDX: transmission electron microscope energy dispersive X-ray spectroscopy) and the element content obtained by inductively coupled plasma-mass spectrometry (ICP-MS), and then confirming that the order of the derived equivalent thickness takes an appropriate value by directly observing the coat based on TEM pictures.

Insulation coat 70 is preferably formed of at least one substance selected from the group consisting of a phosphate compound, silicide compound, titanium compound, zirconium compound, and boron compound. The superior insulation property of these substances allows the eddy current flowing between metal magnetic particles 10 to be suppressed effectively. Specifically, insulation coat 70 is preferably formed of silicon oxide, titanium oxide, zirconium oxide, or the like. Particularly, by employing a metal oxide including phosphate for insulation coat 70, the coating layer on the surface of the metal magnetic particle can be made thinner. Accordingly, the flux density of the magnetic particles can be increased to allow improvement in the magnetic property.

Further, insulation coat 70 may be formed of a metal oxide, metal nitride, metal oxide, phosphate metal compound, borate metal compound, silicate metal compound, or the like, employing, as the metal, Fe, Al, Ca (calcium), Mn, Zn (zinc), Mg (magnesium), V (vanadium), Cr, Y (yttrium), Ba (barium), Sr (strontium), or rare earth element.

Further, insulation coat 70 may be formed of a phosphate amorphous compound of at least one substance selected from the group consisting of Al, Si, Mg, Y, Ca, Zr (zirconium) and Fe, and a borate amorphous compound of the relevant substance.

Moreover, insulation coat 70 may be formed of an oxide amorphous compound of at least one substance selected from the group consisting of Si, Mg, Y, Ca and Zr.

Although the above description is based on a configuration in which the metal particle constituting the soft magnetic material is formed including one layer of an insulation coat, the magnetic particle constituting the soft magnetic material may be formed including a plurality of layers of insulation coats.

The remaining configuration is substantially similar to that of the soft magnetic material of the first embodiment. Therefore, description thereof will not be repeated.

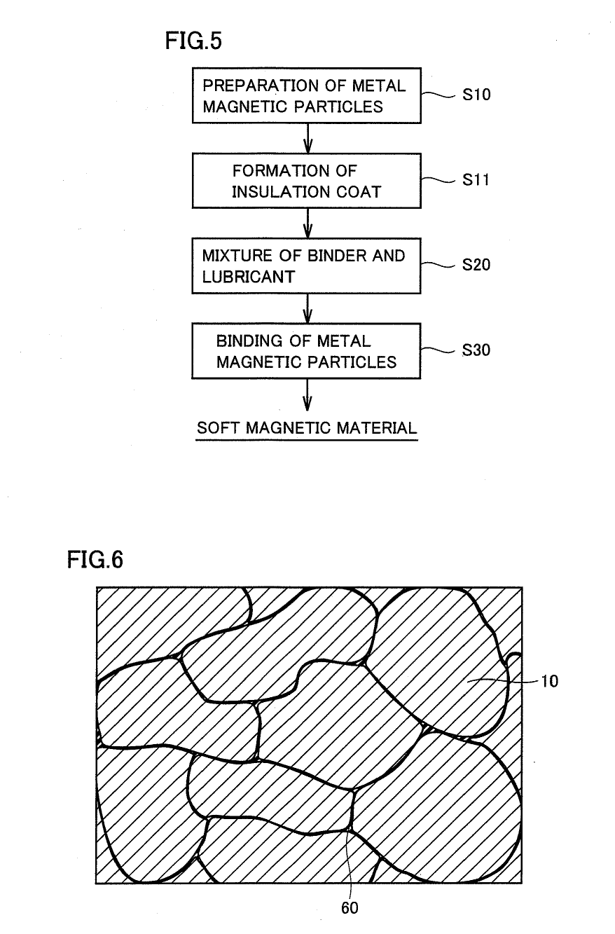

A method of producing a soft magnetic material of the present embodiment will be described with reference to FIGS. 4 and 5. FIG. 5 is a flowchart of a method of producing a soft magnetic material of the present embodiment.

As shown in FIG. 5, the method of producing a soft magnetic material of the present embodiment is basically similar to the method of producing a soft magnetic material of the first embodiment. The difference lies in the further provision of step S11 of forming insulation coat 70.

Specifically, following step S11 of preparing metal magnetic particles 10, an insulation coat 70 surrounding the surface of metal magnetic particle 10 is formed (step S12). In this step S12, insulation coat 70 based on the material set forth above is formed. Particularly, insulation coat 70 is preferably formed including at least one type of substance selected from the group consisting of a phosphorus compound, silicon compound, titanium compound, zirconium compound, boron compound, silicone resin, thermoplastic resin, non-thermoplastic resin, and higher fatty acid.

Insulation coat 70 can be formed by applying, for example, a phosphate chemical treatment to metal magnetic particles 10. As the method of forming an insulation coat of phosphate other than the phosphate chemical conversion treatment, solvent spraying or sol-gel treatment using a precursor may be employed. Alternatively, an insulation coat 70 of a silicon type organic compound may be formed. For the formation of such an insulation coat, a wet coating treatment using an organic solvent or a direct coating treatment by a mixer, or the like may be employed. Thus, insulation coat 70 is formed on the surface of each metal magnetic particle 10 to obtain a plurality of magnetic particles.

Although the above description is based on the case where a magnetic particle constituting the soft magnetic material is formed including one layer of insulation coat 70, the magnetic particle constituting the soft magnetic material may be formed including a plurality of layers of insulation coats 70, as mentioned before.

In the case where the soft magnetic material is produced with a plurality of layers of insulation coats 70, one insulation coat, and another insulation coat surrounding the surface of the one insulation coat are formed. Preferably, one insulation coat is formed of at least one type of substance selected from the group consisting of a phosphorus compound, silicon compound, titanium compound, zirconium compound, and boron compound, whereas another insulation coat is formed of at least one type of substance selected from the group consisting of silicone resin, silicon compound, thermoplastic resin, non-thermoplastic resin, and higher fatty acid salt.

The other steps (S20-S30) are substantially identical to those in the method of producing a soft magnetic material of the first embodiment. Therefore, description thereof will not be repeated.

### Third Embodiment

FIG. 6 schematically represents a dust core of the present embodiment. The dust core of FIG. 6 is produced employing the soft magnetic material of the first embodiment.

Specifically, the dust core of the present embodiment includes a metal magnetic particle 10, and an insulator 60.

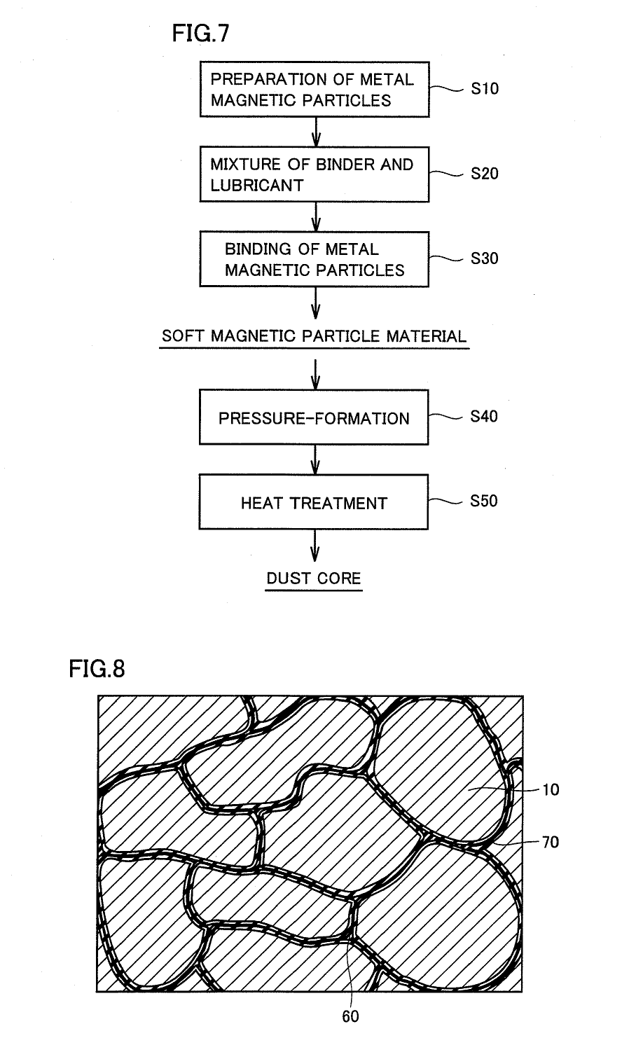

Next, a method of producing a dust core of the present embodiment will be described with reference to FIGS. 6 and 7. FIG. 7 is a flowchart of a method of producing a dust core of the present embodiment.

As shown in FIG. 7, a soft magnetic material is produced in a manner similar to that of the first embodiment (steps S10-S30).

Then, the soft magnetic material is subjected to pressure-formation to produce a compact (step S40). In this step S40, the obtained soft magnetic material is placed in a die, and pressure-formation is carried out at a pressure in the range of 390 MPa to 1500 MPa, for example. Thus, a compact based on the soft magnetic material subjected to pressure-formation is produced.

The filling property of the soft magnetic material in a die at step S40 is high due to the high flowability of the soft magnetic material. This originates from the larger apparent particle size due to the plurality of metal magnetic particles constituting the soft magnetic material being bound by binder 20.

In the pressure-formation at step S40, lubricant 30 is liquefied to be extruded along the face of the die, i.e. extruded along the interface between the compact and the die. In order to facilitate liquefaction of the lubricant, pressure-formation is performed preferably at a temperature greater than or equal to the melting point of the lubricant. When the compact is detached from the die, the extraction pressure can be reduced. Accordingly, generation of a molding defect such as a streak, crack, fracture, and the like in the compact can be suppressed, allowing improvement in moldability.

Since lubricant 30 that is liquefied during pressure-formation is present inside the aggregate of metal magnetic particles 10, in addition to binder 20, lubricant 30 present in binder 20 promotes cohesion failure of binder 20 when the soft magnetic material is subjected to pressure-formation in the die, leading to reduction in the binding force. Accordingly, the plurality of metal magnetic particles 10 bound can be readily separated from each other to facilitate realignment of metal magnetic particles 10. Thus, the density of the compact obtained by pressure-forming the soft magnetic material can be improved.

Then, the compact is subjected to heat treatment (step S50). In this step S50, heat treatment is conducted at the temperature greater than or equal to 400° C. and less than or equal to 900° C., for example. The heat treatment allows removal of the plurality of defects that are generated within the compact subjected to pressure-formation.

After the heat treatment of step S50, the compact is subjected to appropriate processing such as extrusion, and/or grinding, as necessary, to complete the dust core shown in FIG. 6.

### Fourth Embodiment

FIG. 8 schematically represents a dust core of the present embodiment. The dust core of FIG. 8 is produced using the soft magnetic material of the second embodiment.

The dust core of the present embodiment has a configuration basically similar to that of the dust core of the third embodiment. The difference lies in that there is further provided an insulation coat 70 surrounding the surface of a metal magnetic particle 10.

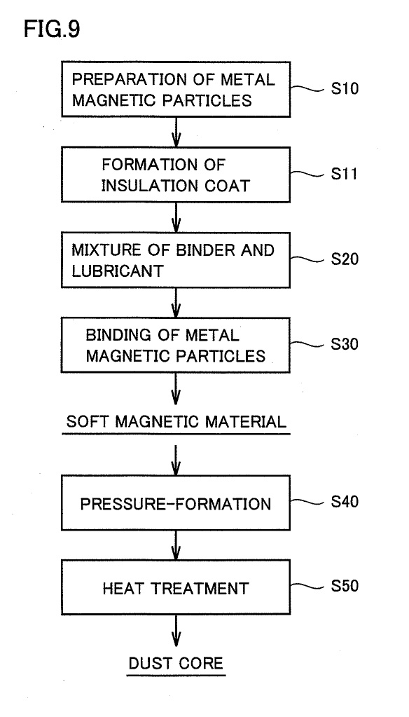

A method of producing the dust core of the present embodiment will be described hereinafter with reference to FIGS. 8 and 9. FIG. 9 is a flowchart of the method of producing the dust core of the present embodiment.

The method of producing a dust core of the present embodiment is basically similar to that of the third embodiment. The difference lies in that step S11 of forming an insulation coat is further provided. Moreover, the temperature of the heat treatment at step S50 differs.

Specifically, as shown in FIG. 9, a soft magnetic material is produced in a manner similar to that of the second embodiment (steps S10-S30). Then, the soft magnetic material is subjected to pressure-formation in a manner similar to that of the third embodiment to produce a compact (step S40). These steps S10-S40 substantially correspond to the method of producing a soft magnetic material of the second embodiment, and step S40 of the third embodiment. Therefore, description thereof will not be repeated.

Then, the compact is subjected to heat treatment (step S50). In this step S50, heat treatment is conducted at a temperature greater than or equal to 400° C. and less than or equal to the thermal decomposition temperature of insulation coat 70. By carrying out the heat treatment at a temperature lower than the thermal decomposition temperature of insulation coat 70, degradation in insulation coat 70 can be suppressed by the heat treatment.

The dust core of FIG. 8 can be produced by steps S10-S50 set forth above.

An electromagnetic component of the present invention will be described hereinafter. An electromagnetic component of the present invention includes the dust core set forth above and a coil. The shape of the dust core includes an annular, rod-like, E-type, I-type core, and the like. A conductive wire with an insulation coat is wound to constitute the coil. The wire can take various cross sectional shapes, such as a round or rectangular shape. For example, a round wire can be wound spirally to constitute a cylindrical coil, or a rectangular wire can be edgewise wound to constitute a rectangular columnar coil.

The electromagnetic component may be configured by winding a wire along the outer circumference of the dust core, or by fitting a hollow coil formed spirally in advance around the outer circumference of the dust core.

Specific examples of such an electromagnetic component includes a high frequency choke coil, high frequency tuning coil, bar antenna coil, power supply choke coil, power supply transformer, switching power supply transformer, reactor, and the like.

### EXAMPLES

The effect of including a lubricant having a melting point less than or equal to 100° C., contained in the plurality of magnetic particles, was evaluated in the examples.

### Inventive Example 1

The dust core of Inventive Example 1 was produced by the method of producing a dust core according to the third embodiment of the present invention (S10-S20).

Specifically, at step S10 of preparing metal magnetic particles, iron powder was subjected to water atomization to obtain metal magnetic particles containing at least 99.6% by weight of iron and the remainder of inevitable impurities, including 0.3% by weight or less of O (oxygen) and 0.1% by weight or less of C, N, P or Mn, to prepare metal magnetic particles. The average particle size of the metal magnetic particles was 10 μm.

Step S20 of mixing a binder with a lubricant was carried out as set forth below. For the binder, dimethyl silicone resin having binding property was prepared. For the lubricant, oleic acid amide having a melting point of 75° C. was prepared. A binder of an amount equivalent to the concentration of 1.8% by mass to the metal magnetic particles that will be mixed afterwards was dissolved in a xylene solvent. Oleic acid amide of an amount equivalent to the concentration of 0.5% by mass to the metal magnetic particles that will be mixed afterwards was added to the solvent and mixed. Thus, an additive including a binder and lubricant was provided.

At step S30 of binding metal magnetic particles, the metal magnetic particles and the additive were mixed. Then, the solvent was removed by drying. Accordingly, a soft magnetic material containing a lubricant having a melting point less than or equal to 100° C. in the aggregate of bound magnetic particles was produced.

At step S40 of forming a compact, the soft magnetic material was filled in a die and subjected to the pressure of 2 ton/cm², 4 ton/cm², 6 ton/cm², 8 ton/cm², 10 ton/cm², and 12 ton/cm² to produce six types of compacts.

At step S50 of heat treatment, each compact was heat-treated for 1 hour at 750° C. in a nitrogen ambient. Thus, the dust core of Inventive Example 1 was produced.

### Inventive Example 2

Inventive Example 2 had a configuration basically similar to that of Inventive Example 1, differing in that stearin acid ester having a melting point of 60° C. was employed for the lubricant. In the formation of a compact, the pressure of 2 ton/cm², 4 ton/cm², 6 ton/cm², 8 ton/cm², 10 ton/cm², and 12 ton/cm² was applied to produce six types of compacts.

### Comparative Example 1

The method of producing a dust core of Comparative Example 2 is basically similar to the method of producing a dust core of Inventive Example 1. The difference lies in that step S20 of mixing a binder and lubricant was not carried out.

Specifically, step S10 of preparing metal magnetic particles was carried out in a manner similar to that of Inventive Example 1.

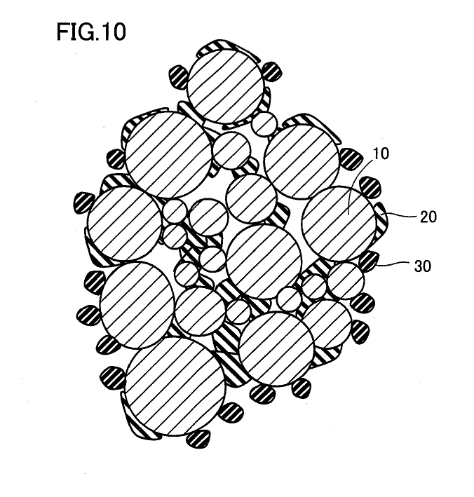

Then, using a binder similar to that of Inventive Example 1, the metal magnetic particles were bound. Then, the lubricant was added. Thus, a soft magnetic material of Comparative Example 1 shown in FIG. 10 was produced. FIG. 10 schematically represents the soft magnetic material of Comparative Example 1. As shown in FIG. 10, almost no lubricant 30 was contained in the aggregate of bound metal magnetic particles 10, and much lubricant 30 was present outside the aggregate of bound metal magnetic particles 10 in the soft magnetic material of Comparative Example 1.

Then, step S40 of pressure-formation and step S50 of heat treatment were carried out, likewise with Inventive Example 1. Thus, the dust core of Comparative Example 1 was produced.

### Comparative Example 2

Comparative Example 2 had a configuration basically similar to that of Comparative Example 1, provided that ethylene bis stearamide having a melting point of 140° C. was employed as the lubricant. In forming a compact, the pressure of 2 ton/cm², 4 ton/cm², 6 ton/cm² and 8 ton/cm² was applied to produce four types of compacts.

### Comparative Example 3

Comparative Example 3 had a configuration basically similar to that of Comparative Example 1, provided that ethylene bis stearamide was employed as the lubricant. In other words, as shown in FIG. 10, the aggregate of the bound metal magnetic particles included almost no ethylene bis stearamide as the lubricant. In forming a compact, the pressure of 2 ton/cm², 4 ton/cm², 6 ton/cm², 8 ton/cm², 10 ton/cm², and 12 ton/cm² was applied to produce six types of compacts.

### Comparative Example 4

Comparative Example 4 had a configuration basically similar to that of Inventive Example 1, differing only in that a lubricant was not added, and that the added amount of the binder differed. Specifically, the soft magnetic material of Comparative Example 4 had 0.6% by mass of binder mixed into the plurality of metal magnetic particles, and no lubricant was added. In forming a compact, the pressure of 2 ton/cm², 4 ton/cm², 6 ton/cm², 8 ton/cm², 10 ton/cm², and 12 ton/cm² was applied to produce six types of compacts.

### Comparative Example 5

Comparative Example 5 had a configuration basically similar to that of Comparative Example 4, differing only in the usage of 1.2% by mass of the binder. In other words, the soft magnetic material of Comparative Example 5 had only 1.2% by mass of binder mixed with the plurality of metal magnetic particles, and no lubricant was added. In forming a compact, the pressure of 2 ton/cm², 4 ton/cm², 6 ton/cm², 8 ton/cm² and 10 ton/cm² was added to produce 5 types of compacts.

### Comparative Example 6

Comparative Example 6 had a configuration basically similar to that of Inventive Example 1, differing only in that a lubricant was not added. Specifically, the soft magnetic material of Comparative Example 6 only had 1.8% by mass of the binder added with the plurality of metal magnetic particles, and no lubricant was added. In forming a compact, the pressure of 2 ton/cm², 4 ton/cm², 6 ton/cm², 8 ton/cm² and 10 ton/cm² was applied to produce 5 types of compacts.

(Method of Measurement)

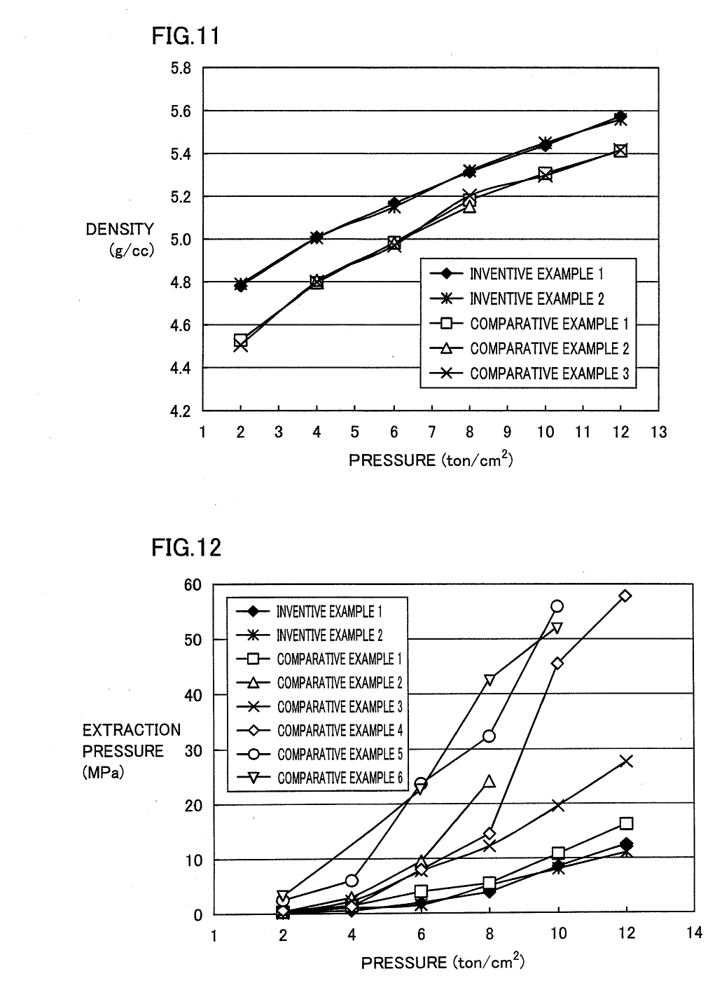

The density of the dust core of Inventive Examples 1 and 2 as well as Comparative Examples 1-3 were measured by the Archimedean method. The results are shown in FIG. 11. FIG. 11 represents the relationship between the pressure applied in pressure-formation and the density of the compact (dust core) in the examples. In FIG. 11, the pressure applied in pressure-formation (unit: ton/cm²) is plotted along the horizontal axis, whereas the compact density is plotted along the vertical axis (unit: g/cm³).

The pressure applied in detaching the compact from the die was measured as the extraction pressure for the dust core of Inventive Examples 1 and 2 as well as Comparative Examples 1-6. The results are shown in FIG. 12. FIG. 12 represents the relationship between the pressure applied in pressure-formation and the extraction pressure in the examples. In FIG. 12, the pressure applied in pressure-formation (unit: ton/cm²) is plotted along the horizontal axis, whereas the extraction pressure (unit: MPa) is plotted along the vertical axis.

(Measurement Results)

The dust core of Inventive Example 1 produced using a soft magnetic material including oleic acid amide in the aggregate of bound metal magnetic particles, and the dust core of Inventive Example 2 produced using a soft magnetic material including stearin acid ester in the aggregate of bound metal magnetic particles had the high density of 4.8 g/cm³ to 5.6 g/cm³, higher than the density of the dust core of Comparative Examples 1-3 based on the same pressure applied in pressure-formation. Namely, it was found that the density can be improved even when the pressure in pressure-formation is low in Inventive Examples 1 and 2.

Further, as shown in FIG. 12, the dust core of Inventive Examples 1 and 2 allowed an extraction pressure lower than that of Comparative Examples 1-6 based on the same pressure applied in pressure-formation. No streaks, cracks and fracture were generated in the compact. The moldability was favorable. Namely, it was found that favorable moldability can be maintained in Inventive Examples 1 and 2 even if the pressure applied in pressure-formation is increased.

The dust core of Comparative Example 1 including almost no lubricant 30 in the aggregate of the bound metal magnetic particles, and including much lubricant 30 external to the aggregate of bound metal magnetic particles 10 had a lower density, as compared to Inventive Example 1, when the pressure applied in pressure-formation was identical to that of Inventive Example 1. Although the extraction pressure was higher than that of Inventive Example 1, the level thereof stayed at 17 MPa in the case where the pressure applied in pressure-formation was 12 ton/cm², maintaining favorable moldability.

Comparative Example 2 employing ethylene bis stearamide having a melting point exceeding 100° C. as a lubricant, and Comparative Example 3 employing ethylene bis stearamide as the lubricant, scarcely contained in the magnetic particles, both had a lower density and higher extraction pressure, as compared to Inventive Examples 1 and 2, when the pressure applied in pressure-formation was identical to those in Inventive Examples 1 and 2. In the case where the pressure applied in pressure-formation exceeded 8 ton/cm² in Comparative Example 2 and exceeded 10 ton/cm² in Comparative Example 3, the extraction pressure was greater than 20 MPa. A streak, crack, fracture, and the like were generated in the compact.

Further, the extraction pressure was lower for Comparative Example 3 not including ethylene bis stearamide than Comparative Example 2 including the same when the pressure applied in pressure-formation was identical. Therefore, it was found that, when the lubricant to be contained in the aggregate of metal magnetic particles has a melting point not less than or equal to 100° C. such as fatty acid monoamide and fatty acid monoester, the advantage of improvement in density and moldability was absent even if a lubricant was contained in the aggregate of metal magnetic particles.

Comparative Examples 4-6 not employing a lubricant showed extremely high extraction pressure. The extraction pressure exceeded 20 MPa even when the pressure applied in pressure-formation was greater than or equal to 8 ton/cm² in Comparative Example 4 and greater than or equal to 6 ton/cm² in Comparative Examples 5 and 6. A streak, crack, fracture, and the like were generated in the compact.

Thus, it was confirmed according to the examples that the provision of a lubricant having a melting point less than or equal to 100° C., contained in an aggregate of bound metal magnetic particles, allows the moldability to be improved by reducing the extraction pressure, and to improve the density.

It should be understood that the embodiments and examples disclosed herein are illustrative and non-restrictive in every respect. The scope of the present invention is defined by the terms of the claims, rather than the description above, and is intended to include any modification within the scope and meaning equivalent to the terms of the claims.

### INDUSTRIAL APPLICABILITY

The dust core produced using the soft magnetic material of the present invention can be employed in, for example, a high frequency choke coil, high frequency tuning coil, bar antenna coil, power supply choke coil, power supply transformer, switching power supply transformer, reactor, and the like.

### DESCRIPTION OF THE REFERENCE SIGNS

10 metal magnetic particle, 20 binder, 30 lubricant, 40 additive, 60 insulator, 70 insulation coat.

1. A soft magnetic material comprising:
a plurality of magnetic particles,
a binder binding said plurality of magnetic particles, and
a lubricant contained in an aggregate of bound magnetic particles, and having a melting point less than or equal to 100° C.

2. The soft magnetic material according to claim 1, wherein said lubricant includes fatty acid monoamide or fatty acid monoester.

3. The soft magnetic material according to claim 1, wherein said lubricant includes unsaturated fatty acid monoamide or unsaturated fatty acid monoester.

4. A compact, produced by applying pressure-formation to the soft magnetic material defined in claim 1.

5. A dust core, produced by applying heat treatment to the compact defined in claim 4.

6. An electromagnetic component comprising:
a dust core defined in claim 5, and
a coil wound around said dust core.

7. A method of producing a soft magnetic material, comprising the steps of:
forming an additive by mixing a binder and a lubricant having a melting point less than or equal to 100° C., and
binding a plurality of magnetic particles by said additive.

8. The method of producing a soft magnetic material according to claim 7, wherein said lubricant including fatty acid monoamide or fatty acid monoester is employed in said step of forming an additive.

9. The method of producing a soft magnetic material according to claim 7, wherein said lubricant including unsaturated fatty acid monoamide or unsaturated fatty acid monoester is employed in said step of forming an additive.

10. A method of producing a dust core, comprising the steps of:
producing a soft magnetic material by the method of producing a soft magnetic material defined in claim 7,
forming a compact by applying pressure-formation to said soft magnetic material, and
heat-treating said compact.

11. The method of producing a dust core according to claim 10, wherein pressure-formation is applied at a temperature higher than a melting point of said lubricant in said step of forming a compact.
